(19) United States
(12) Patent Application Publication
(10) Pub. No.: US 2026/0070167 A1
(43) Pub. Date: Mar. 12, 2026

(54) ASSEMBLY PRESS FOR PRESS-JOINING COMPONENTS, AND METHOD THEREFOR

(71) Applicant: Liebherr-Aerospace Lindenberg GmbH, Lindenberg (DE)

(72) Inventors: Martin DÖHRING, Lindenberg (DE); Daniel ZIMMERMANN, Wangen (DE)

(21) Appl. No.: 19/322,269

(22) Filed: Sep. 8, 2025

(30) Foreign Application Priority Data
Sep. 12, 2024 (DE) 10 2024 126 292.3

(51) Int. Cl. B23P 19/02; B23P 19/10; G01B 11/14

(52) U.S. Cl. CPC B23P 19/02; B23P 19/105; G01B 11/14

(57) ABSTRACT

The disclosure relates to an assembly press for press-joining components, which comprises a linear unit that is configured for moving a component placed thereon back and forth along one direction, an optical measuring unit comprising a detection region directed onto a portion of the linear unit in order to measure a component placed on the linear unit, and a gripper stamp which is configured for lifting a first component, optionally an inner partner, from the linear unit and, after displacement of the linear unit, for joining it to a second component, optionally an outer partner, placed in the detection region.

### CROSS REFERENCE TO RELATED APPLICATION

The present application claims priority to German Patent Application No. 102024 126 292.3 filed on September 12, 2024. The entire contents of the above-listed application are hereby incorporated by reference for all purposes.

### TECHNICAL FIELD

The present disclosure relates to an assembly press for press-joining component, and a method therefor.

### BACKGROUND

In modern manufacturing technology, joining methods play a central role, since they form the basis for the production of complex assemblies and systems. These methods make it possible to interconnect different materials and components in a precise and lasting manner, as a result of which the functionality and reliability of the end products is ensured. One of the most important joining methods is press-joining, in which components are interconnected by the application of pressure. This method is widely used in various fields of industry, from automotive production to aerospace.

### SUMMARY

The press-joining is characterized by its ability to create rigid and permanent connections without the use of additional materials such as adhesives or welding materials. It may be used in applications in which high precision and reliability are required. An example for the use of press-joining is in electrohydraulic servo valves (EHSV) which are for example used in aeronautical technology to precisely control the control surfaces of aircraft, such as ailerons, elevators and rudders. This is decisive for the flight control and maneuverability of the aircraft. In the production and assembly of an EHSV, press-joining is used in order to reliably and precisely connect components of the EHSV such as nozzle, nozzle pipe, armature, torsion shaft, base plate, valve block and beam splitter. These components must withstand extreme operating conditions and therefore require a particularly reliable joining technology.

A disadvantage of a conventional press-in process is that this requires its own, complex device, which is associate both with high costs and with a large space requirement. Furthermore, the desired pressing dimension is achieved with highly precise impacts, but these pressing dimensions are often not adhered to in a process-reliable manner, which leads to the need for re-measuring the desired pressing dimension and a high scrap rate. Furthermore, it follows from this that component tolerances have a negative impact on the joining dimensions, as a result of which the dimensional accuracy of the press connection likewise cannot be ensured in a process-reliable manner. This results, overall, in complex management of the individual joining processes, in which each press-in dimension must be laboriously re-measured after the pressing process.

In addition, on account of the pressing dimensions achieved with the aid of impacts, it is not possible to design these in a variable manner, and therefore a change in the desired geometry (for example the joining depth of the two joining partners) also always leads to extensive changes in the components to be joined together.

The aim of the present disclosure is to provide an assembly press for press-joining components, and/or a method for press-joining components, which overcomes or at least reduces the disadvantages set out above. This is achieved by an assembly press or a method for press-joining . In this case, further advantageous embodiments are found herein.

An assembly press according to the disclosure for press-joining components comprises a linear unit that is configured for moving a component placed thereon back and forth along one direction, an optical measuring unit comprising a detection region directed onto a portion of the linear unit in order to measure a component placed on the linear unit, and a gripper stamp which is configured for lifting a first component, optionally an inner partner, from the linear unit and, after displacement of the linear unit, for joining it to a second component, optionally an outer partner, placed in the detection region.

The combination of linear unit, optical measuring unit and gripper stamp allows for fully automatic press-joining of the components to be joined, which are placed on the linear unit at the start.

The presence of the optical measuring unit thus makes it possible to measure the components, to be joined together, before press-joining and thereafter, such that it is possible to already determine, in an automated manner, before joining of the components whether the components to be joined together adhere to the required tolerances and are capable, at all, for use for the joining process, or are to be considered scrap.

In this case, the linear unit ensures displacement of the components into a detection region of the optical measuring unit and a receiving region of the gripper stamp, such that the gripper stamp optionally actually only has to be capable of performing a movement in the vertical direction. The supplying of the corresponding components into the receiving region of the gripper stamp is performed by the displacement of the linear unit. The gripper stamp therefore does not have to be capable of moving in the direction in which the linear unit can move the different components.

According to the present disclosure, it can be provided that the detection region of the optical measuring unit coincides with the working region of the gripper stamp. This means that joining of a first component to a second component is performed in the detection region of the optical measuring unit, such that measurement by the optical measuring unit is possible directly thereafter or also during the joining process.

According to an optional development of the present disclosure, it can be provided that the gripper stamp is configured for lifting the first component out of the detection region of the optical measuring unit, and/or the optical measuring unit has an accuracy of 1 µm or less.

It can thus be provided that the detection region of the optical measuring unit coincides with the receiving region of the gripper stamp, which has the advantage that after press-joining of two components a joined component can be immediately measured by the optical measuring unit. It is also possible for a partially joined component to initially be measured by the optical measuring unit, in order to identify the distance by which the partially joined component still has to be pressed in, in order to achieve the finally joined component according to the target joining dimension. This information can then be forwarded to the gripper stamp, such that a finally joined component can be achieved that has a particularly high tolerance quality.

A measuring accuracy of the measuring unit of 1 µm or better allows for the creation of press joints with particularly high accuracy.

Furthermore, it can advantageously be provided according to the present disclosure that the linear unit is configured for displacing the second component into the detection region of the optical measuring unit following lifting of the first component by the gripper stamp.

As has already been briefly mentioned, the optical measuring unit is capable of measuring the two components, to be joined together, before a joining process. Thus, in this case, the first component is initially measured, before it is lifted by the gripper stamp, wherein the second component is conveyed into the detection region of the optical measuring unit following lifting. If the second component is also within the predetermined tolerance limits, press-joining occurs by lowering the gripper stamp.

According to a further advantageous development of the present disclosure, it can be provided that the linear unit comprises a die body on which at least one component can be laid and which serves as a stop surface for press-joining by the gripper stamp, optionally wherein the second component and/or the first component are placed on the die body.

The linear unit accordingly has to be equipped with a stable region, which can serve as a base for the press-joining by the gripper stamp. In this case, it can also be provided that the linear unit can shift the die body back and forth, in its entirety.

In order to simplify the arrangement of the components, to be joined together, on the linear unit, it can also be provided that a parts carrier is present, into which the different components are to be inserted. Said parts carrier is then moved by the linear unit.

According to a further optional modification of the present disclosure, it can be provided that the linear unit is configured for displacing or moving out a component, placed thereon, into the detection region of the optical measuring unit.

In this case, it can also be provided that the detection region of the optical measuring unit and the working region of the gripper stamp intersect with one another, such that the working region of the gripper stamp is located in the detection region of the optical measuring unit. This is advantageous inter alia because the optical measuring unit can also be operated during press-joining and can give immediate feedback to the gripper stamp regarding the extent to which further pressing is or is not required.

The disclosure also relates to a method for press-joining components, in particular with an assembly press according to any of the implementations described above, comprising the steps of:

placing a first component, optionally an inner partner, and a second component, optionally an outer partner, on a linear unit,

measuring the first component by an optical measuring unit and checking the correctness and/or the dimensional accuracy of the first component against predefined target values,

receiving the first component by a gripper stamp and lifting it from the linear unit,

placing the second component under the gripper stamp by displacing the linear unit,

measuring the second component by the optical measuring unit and checking the correctness and/or the dimensional accuracy of the first component against predefined target values,

lowering the gripper stamp that receives the first component, for press-joining to the second component placed under the gripper stamp,

determining a joining dimension by the optical measuring unit, and comparing the measured joining dimension with a joining dimension target value,

lowering the gripper stamp again, in order to re-press a difference between the measured joining dimension and the joining dimension target value.

It is thus provided in this case, according to the disclosure, that the two components to be joined together are each measured by the optical measuring unit, and the method is continued only when the measurement has shown that the individual components are within a predetermined tolerance range. If this is not the case, rejection of the components not within the tolerance range occurs.

However, if both the first component and the second component are within a predetermined tolerance range, press-joining occurs in that the gripper stamp receives and lifts the first component and, after a displacement of the second component into the working region of the gripper stamp, joins said first component to the second component. In this case, the second component arranged on the linear unit is measured, for correct positioning, before joining, such that lowering of the gripper stamp leads to correct contact of the two joining partners. In this case, the linear unit is designed to be stable, such that the press-joining can be performed directly on the linear unit. It can thus be provided that the linear unit comprises or displaces a die for forming a mating surface during press-joining.

Furthermore, upon joining of the two components pressing initially does not take place to the final dimension, but rather initially to a basic dimension, which differs from the final joining dimension (the joining dimension target value). The joining part that is joined as far as the basic dimension is measured by the optical measuring unit, such that information can be transmitted to the gripper stamp regarding the amount by which a further press joining has to press in the joining partners further, in order to achieve the joining dimension target value (i.e. the final dimension). This contributes to improved accuracy and reduces the scrap rate.

The component that is joined up to the final dimension can in turn be measured again by the optical measuring unit, in order to determine the final dimensions of the joined component and to assess whether or not these are within a predetermined tolerance range. If this not the case, the joined component is scrap, whereas in the case of dimensions within the tolerance range a very precisely manufactured joining component has been created.

According to an optional development of the present method it can be provided that the respective component is rejected on the basis of the measurement of the first and/or the second component, or the following steps are performed with the respective component.

The individual joining partners are therefore already checked for correctness and dimensional accuracy before press-joining.

It can furthermore be provided, according to an advantageous embodiment of the present disclosure, that the linear unit is actuated on the basis of the measurement of the first component and before the first component is received by the gripper stamp, in order to position the first component exactly for reception by the gripper stamp.

In this case, the exact positioning of the second component in the working region of the gripper stamp can be verified with the aid of the optical measuring unit. Thus, for this purpose, the optical measuring unit is used for detecting the position of the second component, which is to be joined to the first component lifted by the gripper stamp, such that exact positioning is ensured. In this case, a movement of the linear unit can be prompted from a result for determining the position of the second component by the optical measuring unit.

It can advantageously be provided, according to the disclosure, that the linear unit is actuated on the basis of the measurement of the second component and before the gripper stamp is lowered for press-joining, in order to position the second component exactly, relative to the gripper stamp, for press-joining.

According to an optional modification of the present method, it can be provided that

(i) the press-in forces during the press-joining are stored and/or monitored, and/or

(ii) the values of the first component and/or of the second component obtained upon measurement by the optical measuring unit are stored, and

the press-in forces and/or the values obtained upon measurement are transferred into an assembly log.

The storage of the press-in forces during the press-joining and the storage of the dimensions of the two components to be joined together, or also of the joined component, can be logged in an assembly log, in order to comply with any requirements with respect to quality control. Furthermore, the storage of these values is, however, advantageous in particular for an optimization algorithm, which is optionally operated with the aid of artificial intelligence, and consults the stored information for the optimization.

It can furthermore be provided, in this case, that after a re-pressing by lowering the gripper stamp again, the pressed part obtained by press-joining is measured by the optical measuring unit, in order to obtain the joining dimension of the pressed part.

According to a further optional development of the present disclosure, it can be provided that the joining dimension of the pressed part together with the values of the first component and of the second component obtained upon measurement by the optical measuring unit are stored, optionally together with the press-in forces exerted upon press-joining and/or upon re-pressing, in order to optimize the press-in forces upon press-joining and upon re-pressing, and/or a positioning of the components by the linear unit, with the aid of an optimization algorithm that is optionally based on artificial intelligence.

According to a further development of the present disclosure, it can be provided that upon lowering of the gripper stamp for press-joining and/or for re-pressing, joining on measure and not joining on block is performed.

It can furthermore be provided according to the disclosure that the forces exerted upon press-joining are exerted and/or monitored depending on a measurement of the first component and/or of the second component, in order to allow for automatic press-joining of different components.

It can advantageously be provided that a plurality of first components and a plurality of second components is arranged on the linear unit, and after press-joining of a first component to a second component, press-joining of a further first component to a further second component is continued with.

### BRIEF DESCRIPTION OF THE FIGURES

Further features, details and advantages of the disclosure are clear from the following description of the figures, in which:

FIG. 1: is a schematic view of an assembly press according to the disclosure, and

FIG. 2A-FIG. 2B: schematically show an implementation of the method according to the disclosure.

### DETAILED DESCRIPTION

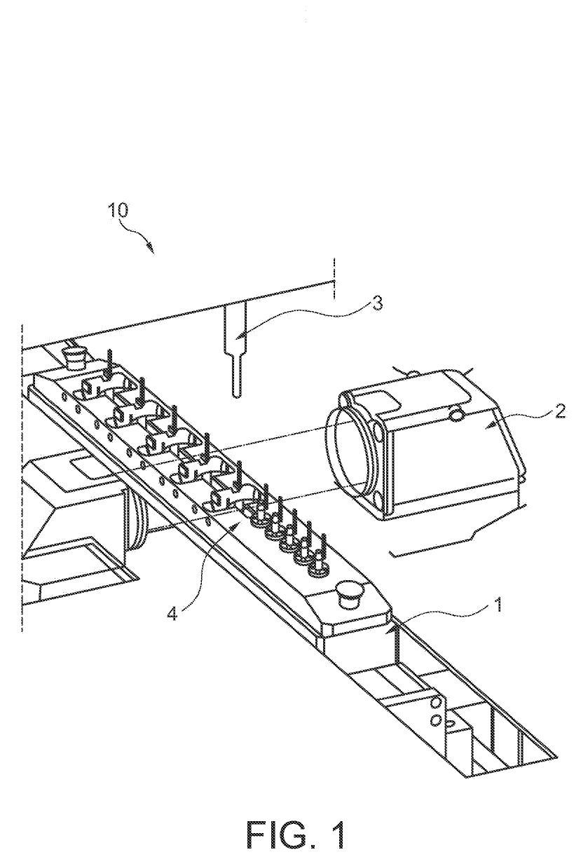

FIG. 1 is a schematic view of an assembly press 10 according to the present disclosure.

The linear unit 1 is visible, on which a plurality of components is placed. In this case, a first of the plurality of components is to be pressed into a second of the plurality of component via press-joining, in order to form a joined component.

The linear unit is capable of moving the plurality of components back and forth in one direction, wherein the displacement path of the linear unit crosses a detection region of an optical measuring unit 2. The optical measuring unit 2 can now measure the component, placed in its detection region, exactly with respect to its dimensioning and its positioning relative to the gripper stamp.

Furthermore, the assembly press 10 according to the disclosure comprises a gripper stamp 3 which is configured for receiving and lifting a first component from the linear unit 1 in order, after displacement of the linear unit 1, in which a second component has been placed directly under the gripper stamp 3, to bring about press-joining of the two components to one another.

According to the assembly press 10, in this case the procedure of press-joining also takes place within the detection region of the optical measuring unit 2, in order for example after a first press-joining, in which the two components joined together have not yet been pressed in to their final dimension, to perform a measurement of the not yet finally pressed-in component, in order to find out the extent to which, in a further pressing process, the components already partially pressed together still have to be pressed in.

A superordinate control unit, which is connected to the linear unit 1, the optical measuring unit 2 and the gripper stamp 3 and stores the respective parameters of the different settings and actions of the assembly press 10 during press-joining, is not shown. This information can be used subsequently to perform an optimization algorithm which aims to improve the press-joining. In this case, the optimization algorithm can work with the aid of artificial intelligence and automatically perform an optimization of the settings and actions of the assembly press 10.

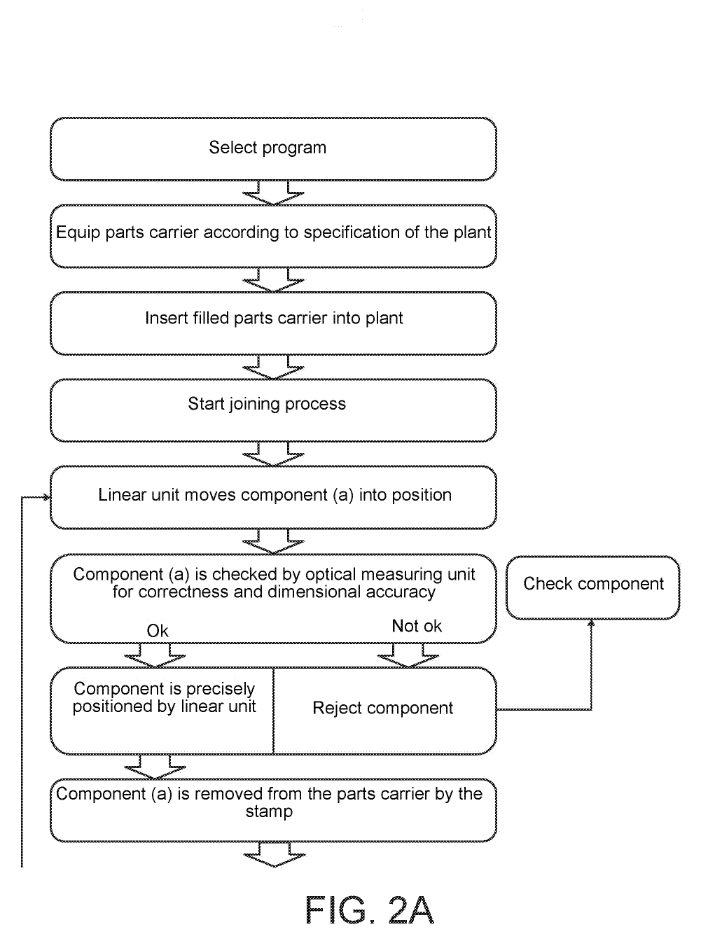

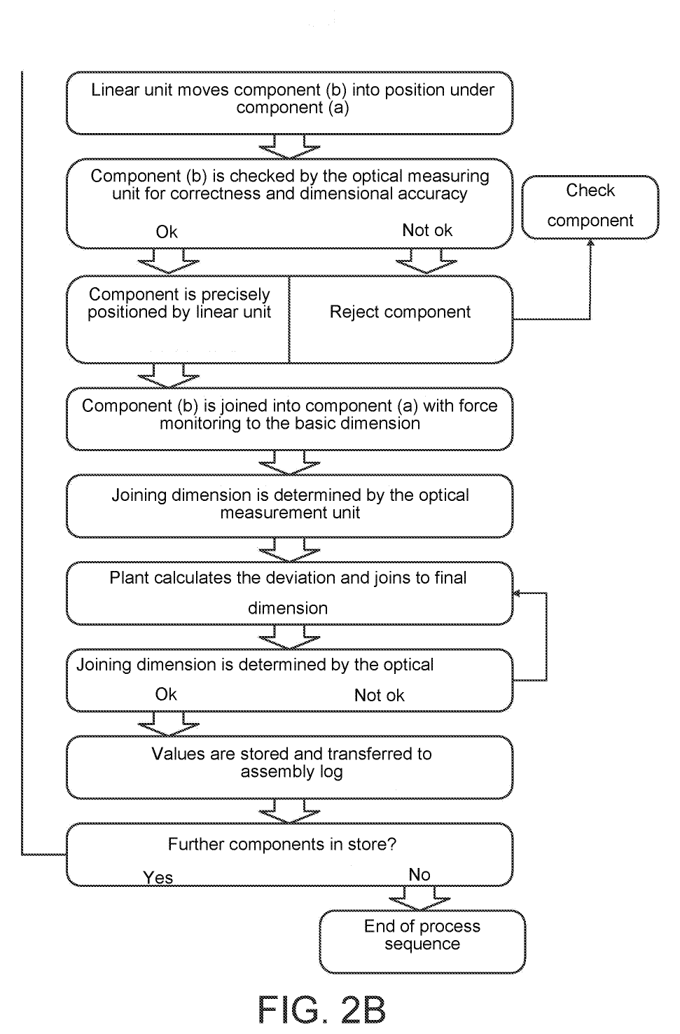

FIG. 2A-FIG. 2B show a flowchart of the method according to the disclosure for press-joining, wherein the flowchart, on account of its size, has been divided over two different pages of drawings, FIG. 2A and FIG. 2B.

Firstly, a specific program for press-joining two constituent parts is selected, and a parts carrier 4 is equipped according to the specifications of the plant. In this case, in the further course of the method the parts carrier can interact with the linear unit, such that the linear unit is capable of shifting the components arranged in the parts carrier 4. Thus, if the parts carrier 4 has been filled and inserted into the plant, the machine that operates according to the method starts the joining process.

Initially, the first component is moved to a predetermined position in which the optical measuring unit has its detection region.

Then, the first component is checked for correctness and dimensional accuracy with the aid of the optical measuring unit, such that it is possible to identify whether or not the component is within the predetermined tolerance limits. If this is not the case, this leads to rejection of the component, such that subsequently a manual check of the rejected component can take place. If, in contrast, the dimensional accuracy of the first component is correct, exact positioning of the first component can take place, for grasping by the gripper stamp. In this case, for example the first component is positioned directly under the gripper stamp, such that lowering of the gripper stamp makes it possible for the first component to be received.

If the first component has been removed by the gripper stamp out of the parts carrier or from the linear unit, the linear unit now displaces the second component, the joining partner, into a detection region of the optical measuring unit, in order to also check the second component for its dimensional accuracy and its correctness.

Here, too, in the case of a deviation from allowable tolerance values the second component is rejected, whereas the joining procedure is continued if the second component is acceptable. Then, the second component is positioned exactly, relative to the gripper stamp, by the linear unit, such that lowering of the gripper stamp, which holds the first component, leads to joining to the second component.

If the positioning of the second component is completed, lowering of the gripper stamp and press-joining of the two components to a basic dimension occurs. In this case, the exerted pressing force is monitored, such that unexpected damage to the components to be joined cannot occur.

In this case, the basic dimension to which the two components are joined in this first joining step deviates from the final joining dimension, which the component to be joined is intended to exhibit after completion of the joining method.

The components joined to the joining dimension are measured by the optical measuring unit such that a difference of the measured joined component up to the ultimate final target joining dimension is determined. Depending on the value determined in this case, for a further joining step by the gripper stamp a corresponding force and/or deflection is determined, which is necessary for precisely achieving the desired dimensioning of the joined component.

If the further joining step for reaching the final dimension has been performed, the final joining dimension of the joined component is verified by the optical measuring unit. If it is identified in this case that the final joining dimension has not yet been reached, a further joining step by the gripper stamp occurs, such that the component to be joined is as far as possible within the sought tolerances, which is identified by a further check.

In contrast, if the joined component meets the requirements, the values consulted for the press-joining, with respect to the press-in forces and/or measurement of the individual components and/or the joined component obtained in the intermediate step or in the final step are stored and transmitted to an assembly log.

Furthermore, the stored information can also be used for an optimization algorithm, which optimizes the settings or actions of the method on the basis of artificial intelligence, in order to obtain better results or the same results with reduced outlay.

If the press-joining of two components has been completed and a joined component has been produced, a check is made as to whether further components are arranged on the linear unit, which are to be joined together. If this is the case, a further first component is displaced by the linear unit into the detection region of the optical measuring unit, and the joining method starts from the beginning.

Due to the joining on measure and not on block, according to the method according to the disclosure tolerances of smaller than or equal to 10 µm, optionally of smaller than or equal to 1 µm, are achieved, wherein the compensation of component tolerances of the first component or of the second component is possible thereby.

### List of Reference Signs

1 linear unit

2 optical measuring unit

3 gripper stamp

4 parts carrier

10 assembly press

1. Assembly press for press-joining components, comprising:
a linear unit which is configured for moving a component placed thereon back and forth along one direction,
an optical measuring unit comprising a detection region directed onto a portion of the linear unit, in order to measure a component placed on the linear unit, and
a gripper stamp which is configured for lifting a first component, from the linear unit and, after displacement of the linear unit, for joining it to a second component placed in the detection region.

2. Assembly press according to claim 1, wherein
the gripper stamp is configured for lifting the first component out of the detection region of the optical measuring unit, and/or
the optical measuring unit has an accuracy of 1 µm or better.

3. Assembly press according to claim 1, wherein the linear unit is configured for displacing the second component into the detection region of the optical measuring unit following lifting of the first component by the gripper stamp.

4. Assembly press according to claim 1, wherein the linear unit comprises a die body on which at least one component can be laid and which serves as a stop surface for press-joining by the gripper stamp, wherein the second component and/or the first component are placed on the die body.

5. Assembly press according to claim 1, wherein the linear unit is configured for displacing or moving out the component placed thereon into the detection region of the optical measuring unit.

6. Method for press-joining components, with an assembly press according to claim 1, comprising the steps of:
placing a first component, including an inner partner, and a second component, including an outer partner, on a linear unit,
measuring the first component by an optical measuring unit and checking the correctness and/or the dimensional accuracy of the first component against predefined target values,
receiving the first component by a gripper stamp and lifting it from the linear unit,
placing the second component under the gripper stamp, by a displacement of the linear unit,
measuring the second component by the optical measuring unit and checking the correctness and/or the dimensional accuracy of the second component against predefined target values,
lowering the gripper stamp that receives the first component, for press-joining to the second component placed under the gripper stamp,
determining a joining dimension by the optical measuring unit, and comparing the measured joining dimension with a joining dimension target value,
lowering the gripper stamp again, in order to re-press a difference between the measured joining dimension and the joining dimension target value.

7. Method according to claim 6, wherein the respective component is rejected on the basis of the measurement of the first and/or the second component, or the following step is performed with the respective component.

8. Method according to claim 6, wherein the linear unit is actuated on the basis of the measurement of the first component and before the first component is received by the gripper stamp, in order to position the first component exactly for reception by the gripper stamp.

9. Method according to claim 6, wherein the linear unit is actuated on the basis of the measurement of the second component and before the gripper stamp is lowered for press-joining, in order to position the second component exactly, relative to the gripper stamp, for press-joining.

10. Method according to claim 6, wherein
(i) the press-in forces during the press-joining are stored and/or monitored, and/or
(ii) the values of the first component and/or of the second component obtained upon measurement by the optical measuring unit are stored, and
the press-in forces and/or the values obtained upon measurement are transferred into an assembly log.

11. Method according to claim 6, wherein after a re-pressing by lowering the gripper stamp again, the pressed part obtained by press-joining is measured by the optical measuring unit, in order to obtain the joining dimension of the pressed part.

12. Method according to claim 11, wherein the joining dimension of the pressed part together with the values of the first component and of the second component obtained upon measurement by the optical measuring unit are stored, together with the press-in forces exerted upon press-joining and/or upon re-pressing, in order to optimize the press-in forces upon press-joining and upon re-pressing, and/or a positioning of the components by the linear unit, with the aid of an optimization algorithm that is based on artificial intelligence.

13. Method according to claim 6, wherein upon lowering of the gripper stamp for press-joining and/or for re-pressing, joining on measure and not joining on block is performed.

14. Method according to claim 6, wherein the forces exerted upon press-joining are exerted and/or monitored depending on a measurement of the first component and/or of the second component, in order to allow for automatic press-joining of different components.

15. Method according to claim 6, wherein a plurality of first components and a plurality of second components is arranged on the linear unit, and after press-joining of a first component to a second component, press-joining of a further first component to a further second component is continued with.

16. Assembly press for press-joining components, comprising:
a linear unit which is configured for moving a component placed thereon back and forth along one direction,
an optical measuring unit comprising a detection region directed onto a portion of the linear unit, in order to measure a component placed on the linear unit, and
a gripper stamp which is configured for lifting an inner partner from the linear unit and, after displacement of the linear unit, for joining it to an outer partner placed in the detection region.
